(19) United States
(12) Patent Application Publication
(10) Pub. No.: US 2026/0101174 A1
(43) Pub. Date: Apr. 9, 2026

(54) METHODS, ARCHITECTURES, APPARATUSES AND SYSTEMS FOR ASSOCIATING USIMS WITH A DUALSTEER DEVICE

(71) Applicant: InterDigital Patent Holdings, Inc., Wilmington, DE (US)

(72) Inventors: Magurawalage Chathura Madhusanka Sarathchandra, London (GB); Rocco Di Girolamo, Laval (CA); Taimoor Abbas, Sainte-Julie (CA); Xavier De Foy, Kirkland (CA); Anuj Sethi, Ottawa (CA); Guanzhou Wang, Brossard (CA)

(21) Appl. No.: 18/906,016

(22) Filed: Oct. 3, 2024

(51) Int. Cl. H04W 8/22; H04W 8/20; H04W 8/26; H04W 60/04

(52) U.S. Cl. CPC H04W 8/22; H04W 8/20; H04W 8/26; H04W 60/04

(57) ABSTRACT

This disclosure relates to methods, architectures, apparatuses, and systems for USIM association in a WTRU with DualSteer capabilities. The WTRU may physically include two (or more) separate user equipments (UEs) in one physical device, or it may logically couple at least two separate UEs into a logical device. A trigger condition prompts the WTRU to cause the wireless network to register each UE using association information that connects the respective UEs to each other and to the WTRU. The wireless network authorizes the WTRU to perform DualSteer functions using each of the UEs for a duration of time during which the association is valid. The WTRU performs DualSteer functions until the time duration lapses or there is a trigger to disassociate the UEs. These DualSteer functions include at least switching, steering, splitting, or duplicating communications between the WTRU and the wireless network.

### TECHNICAL FIELD

The present disclosure is generally directed to the fields of communications, software and encoding, including, for example, to methods, architectures, apparatuses, systems related to multiple universal subscriber identity module (USIM) association for a DualSteer device.

### SUMMARY

This disclosure relates to USIM association in a WTRU with DualSteer capabilities. The WTRU may physically include two (or more) separate user equipments (UEs) in one physical device, or it may logically couple at least two separate UEs into a logical device. The WTRU causes the wireless network to register each UE using association information that connects the respective UEs to each other and to the WTRU, such that the WTRU is authorized by the network to perform DualSteer functions using each of the UEs. These DualSteer functions include at least switching, steering, splitting, or duplicating communications between the WTRU and the wireless network. Because the wireless network has associated the two UEs with the single WTRU, and has authorized the WTRU to perform DualSteer functions based on the association, communications between the WTRU and the wireless network may be better managed.

In accordance with certain embodiments of the present disclosure, methods and systems are provided for operating a WTRU (e.g., a DualSteer device) including a first UE (having a first USIM) and a second UE (having a second USIM). The WTRU can detect a trigger to associate the first and second USIMs with the WTRU. In response, the WTRU cause a series of communications to occur between the WTRU and the wireless network to associate the USIMs with the DualSteer device. These communications include: the WTRU (e.g., the first UE) sending a first message indicating DualSteer capabilities for the WTRU based on the first UE and the second UE; the first UE receiving a second message including an authorization of DualSteer capabilities and association information for the first USIM and the second USIM with respect to the WTRU; the first UE sending a third message to the second UE indicating the association information and the authorized DualSteer capabilities; the WTRU (e.g., the second UE) sending a fourth message to the wireless network indicating the association information; and the second UE receiving a fifth message including an authorized time duration during which an association between the first USIM and the second USIM with the WTRU is valid. After receiving the fifth message, the WTRU performs DualSteer functions using the first and second UEs based on the time duration and on the authorized DualSteer capabilities.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system, according to some embodiments of this disclosure;

FIG. 1B is a system diagram illustrating an example wireless transmit/receive unit (WTRU) that may be used within the communications system illustrated in FIG. 1A, according to some embodiments of this disclosure;

FIG. 1C is a system diagram illustrating an example radio access network (RAN) and an example core network (CN) that may be used within the communications system illustrated in FIG. 1A, according to some embodiments of this disclosure;

FIG. 1D is a system diagram illustrating a further example RAN and a further example CN that may be used within the communications system illustrated in FIG. 1A, according to some embodiments of this disclosure;

FIG. 2 shows an illustrative non-roaming dual steering architecture, according to some embodiments of this disclosure;

FIG. 3 shows an illustrative Dual steering architecture with roaming in one access, according to some embodiments of this disclosure;

FIG. 4 shows an illustrative Dual steering architecture with roaming in both accesses with common VPLMN, according to some embodiments of this disclosure;

FIG. 5 shows an illustrative Dual steering architecture with roaming in both accesses with two different VPLMNs, according to some embodiments of this disclosure;

FIG. 6 shows an illustrative an exemplary system, according to some embodiments of this disclosure;

FIG. 7 shows an illustrative messaging and data flow architecture for registration of a secondary SUPI, according to some embodiments of this disclosure;

FIG. 8 shows an illustrative messaging and data flow architecture for registration of a secondary SUPI, according to some embodiments of this disclosure;

FIG. 9 shows an illustrative messaging and data flow architecture for a first registration procedure for associating USIMs with the same DualSteer device, according to some embodiments of this disclosure;

FIG. 10 shows an illustrative messaging and data flow architecture for a second registration procedure for associating USIMs with the same DualSteer device, according to some embodiments of this disclosure; and

FIG. 11 is a flowchart of illustrative steps for associating USIMs with a DualSteer device, according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

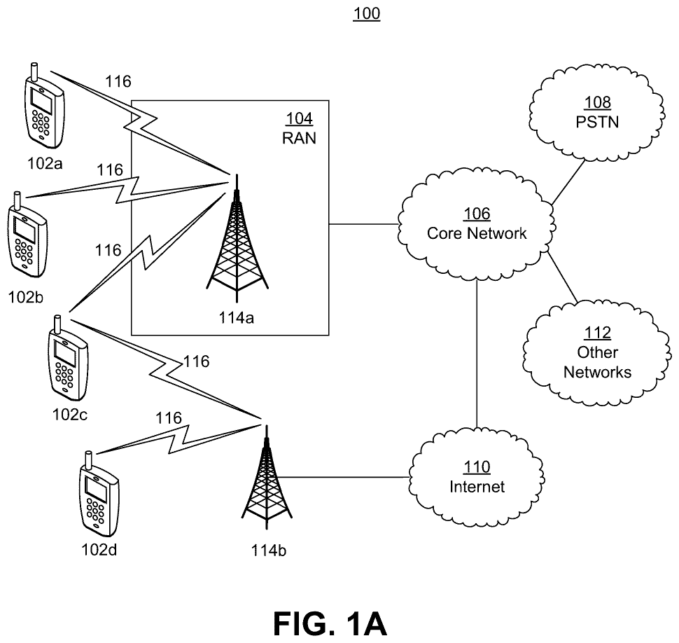

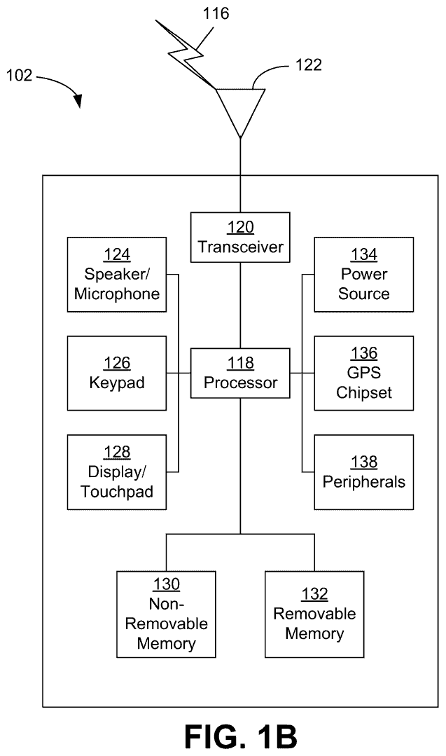

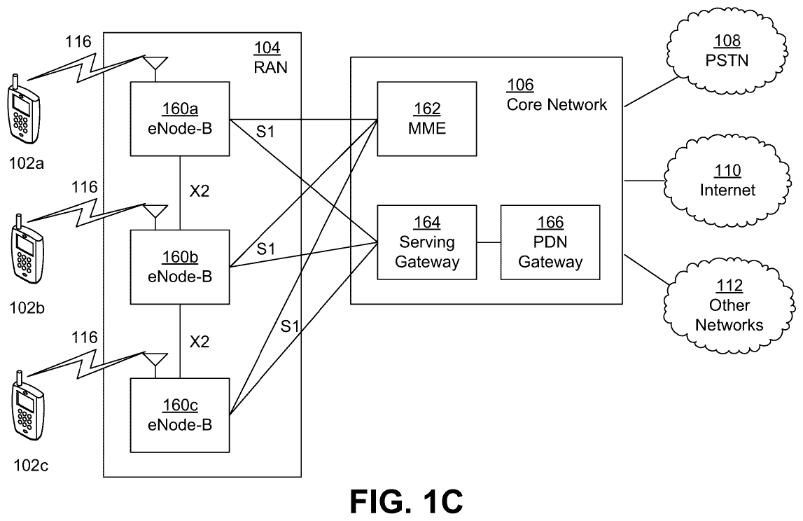

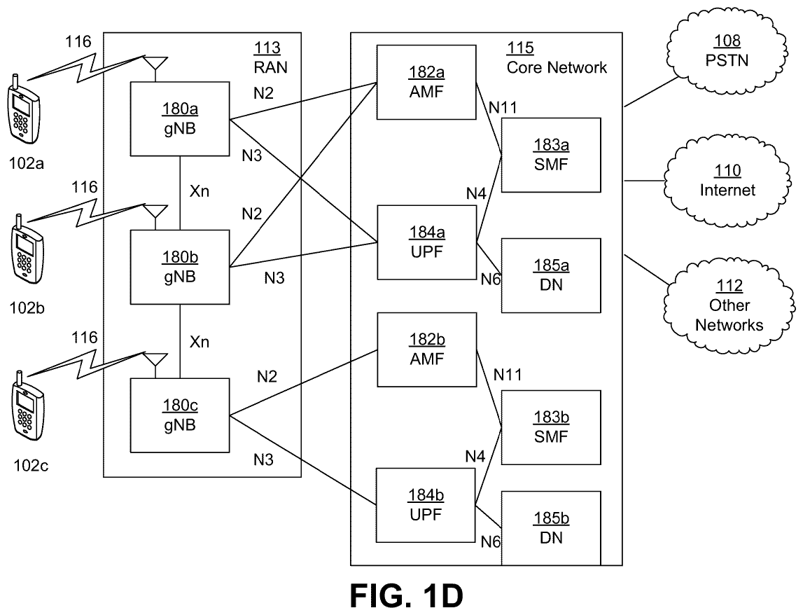

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, if that WTRU includes only one active UE. Any of the WTRUs 102a, 102b, 102c and 102d may be interchangeably referred to as a DualSteer device if that WTRU includes two or more active UEs (e.g., within a single physical device, or as a logical device), or otherwise as a MultiSteer device if that WTRU includes more than two active UEs (e.g., within a single physical device, or as a logical device). A WTRU that is operating as a DualSteer device may include two UEs that are not physically connected or co-located, but rather are logically coupled to perform coordinated DualSteer functions (e.g., where such a WTRU may be referred to as a logical device).

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 (e.g., as a DualSteer or MultiSteer device) may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an (e.g., DualSteer device) embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers (e.g., in a DualSteer or MultiSteer device embodiment) for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

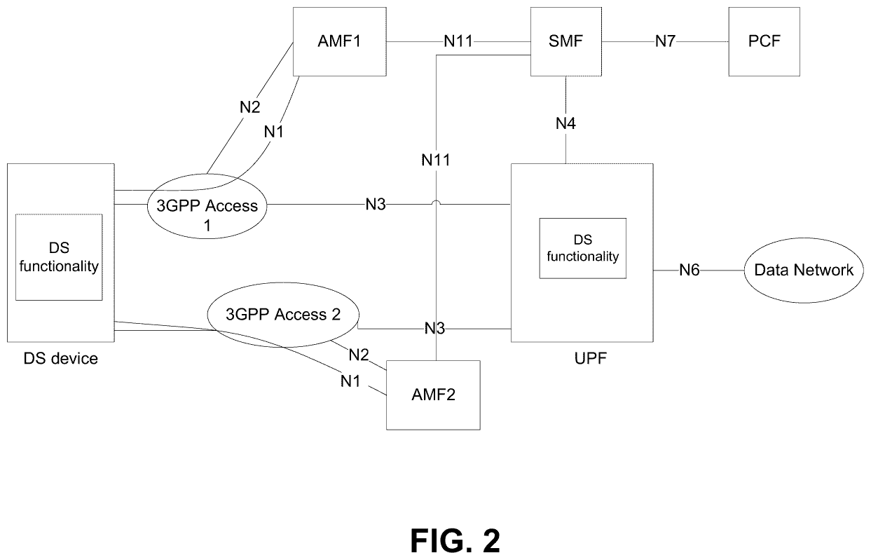

In accordance with some embodiments of this disclosure, the devices and systems of FIGS. 1A-1D may be used in connection with devices, systems, and methods for associating more than one USIM with a DualSteer or MultiSteer device. For example, the devices and systems of FIGS. 1A-1D may be used in connection with the devices, systems, and methods described in FIGS. 2-9, in some embodiments of this disclosure.

In accordance with some embodiments of this disclosure, session and obility management are provided as follows.

In certain representative embodiments, UEs may provide both their Session Management (SM) and Mobility Management (MM) capability to the core network. A UE shall send the UE MM Core Network Capability information to the Access and Mobility management Function (AMF) during the Initial Registration procedure and Mobility Registration Update procedure, within a Non-Access Stratum (NAS) message. Similarly, a UE may include its 5GSM (5G Session Management) Core Network Capability in PDU Session Establishment/Modification Requests. These latter messages may include the UE's Access Traffic Steering, Switching and Splitting (ATSSS) capabilities.

In certain representative embodiments, UEs may perform registration to a network if they need to access services requiring registration. In order to perform this registration, the UE may need to perform a series of steps:

Public Land Mobile Network (PLMN) selection or Standalone Non-Public Network (SNPN) selection—procedure by which a UE may select a mobile network. This network may be a public network or a non-public network. The UE may follow rules to determine how to select from the available networks at a given location, and to determine when to look for higher priority networks.

Cell selection/reselection may describe a procedure by which a UE “camps” on a cell.

Registration may describe a procedure to inform network about the UE presence and provide some coarse location information and capability exchange and negotiations.

In accordance with some embodiments of this disclosure, splitting traffic across two 3GPP access legs is provided as follows.

In certain representative embodiments, carrier aggregation may be provided over a single 3GPP access (for example New Radio (NR) or Long Term Evolution (LTE)) but allows the UE to receive over two or more cells. The cells may be each on a different frequency carrier. The use of the two cells may be managed entirely in the Radio Access Networks (RAN).

In certain representative embodiments, UEs also support Dual Connectivity (DC). DC allows a UE to receive/transmit over two 3GPP accesses (or 3GPP access legs). The accesses may be NR (gNB) or LTE (eNB). In certain representative embodiments, in 5G, the deployments may have one leg over LTE and a second leg over NR. In certain representative embodiments, deployments of DC may also support two legs over NR. In this case, the two legs may be on different bands (e.g., FR1 and FR2). In order to employ DC, a UE may need the Radio Frequency (RF) front end to support both accesses. In dual connectivity, one leg may be the master leg (and part of a Master Cell Group (MCG)), and the other leg may be the secondary leg (and part of a Secondary Cell Group (SCG)) In certain representative embodiments, for the Public Land Mobile Network PLMN plus PLMN/Non-Public Network (NPN) examples, the two networks may be managed by the same operator or by different operators (assumed to have a business agreement among them).

In accordance with some embodiments of this disclosure, traffic steering and switching over two 3GPP access networks is provided as follows.

In certain representative embodiments, 3GPP may support mechanisms that enable traffic steering, switching and splitting between a 3GPP access network (e.g., Evolved Universal Terrestrial Radio Access E-UTRA or NR) and a non-3GPP access network (e.g., WiFi) since 4G. In certain representative embodiments, a mechanism may be ATSSS feature. In certain representative embodiments, new mechanisms to support traffic steering and switching over two 3GPP access networks are provided.

In certain representative embodiments, a DualSteer Device may support traffic steering and switching of user data (for different services) across two 3GPP access networks; it may be be (a) a single UE, in case of non-simultaneous data transmission over the two networks, or (b) two separate UEs in case of simultaneous data transmission over the two networks. The subscriber of the DualSteer Device may have two subscriptions/SUPIs, sharing one subscription profile from the same operator. For any particular service, at any given time, the DualSteer Device may transmit all traffic of that service using only a single 3GPP access network. A DualSteer device may be the WTRU 102 of FIG. 1B that has DualSteer capabilities.

In certain representative embodiments, there is provided various scenarios of two 3GPP access types (e.g., NR, Non-Terrestrial NR, E-UTRA) and the network types (e.g., Home-Public Land Mobile Network (H-PLMN), Visited-Public Land Mobile Network (V-PLMN), Public Network Integrated-Non-Public Network (PNI-NPN)) that the 3GPP access networks may be connected to.

In certain representative embodiments, requirements for supporting DualSteer may include at least one of the following:

A “DualSteer device” may use two SUPIs from the same operator for accessing two separate 3GPP access networks. And each SUPI may be used to connect to only one of the 3GPP access networks at any given time.

A “DualSteer device” may send its user data over two 3GPP access networks belong to the same PLMN, either non-simultaneously or simultaneously.

A “DualSteer device” may send its user data over two 3GPP access networks belong to two different PLMNs, either non-simultaneously or simultaneously.

In case of non-simultaneous data transmission over two networks, a “DualSteer device” may be a single UE. In case of simultaneous data transmission, a “DualSteer device” may be “two separate UEs”.

In case of simultaneous data transmission, the data over two separate networks may belong to different services (or different Service Data Flows).

At any given point of time, all traffic of a single service may be sent over a single access network, i.e., no service data splitting.

In accordance with some embodiments of this disclosure, various UE identities are provided as follows.

In certain representative embodiments, the Subscription Permanent Identifier (SUPI) may be a 5G globally unique identifier allocated to each subscriber. The SUPI value may be provisioned in Universal Subscriber Identity Module (USIM) and UDM/UDR function in 5G Core. The SUPI may be either an International Mobile Subscriber Identifier (IMSI) or a Network Access Identifier (NAI). For the IMSI version of the SUPI, the first three digits represent the Mobile Country Code (MCC), the next two or three represent the Mobile Network Code (MNC) identifying the network operator or PLMN. The remainder may represent the Mobile Subscriber identification number (MSIN).

In certain representative embodiments, Subscription Concealed Identifier (SUCI) is a privacy preserving identifier containing the concealed SUPI. The SUCI may include the PLMN ID of the home network (in MCC and MNC). The MCC/MNC may be transmitted in plain text.

In certain representative embodiments, the 5G GUTI (Globally Unique Temporary Identifier) may be allocated by the AMF (Access and Mobility Management Function). The AMF may assign a new 5G-GUTI to the UE at any time. The 5G-GUTI comprises a GUAMI (Globally Unique AMF ID) and a 5G-TMSI (Temporary Mobile Subscriber Identity), where GUAMI identifies the assigned AMF and 5G-TMSI identifies the UE uniquely within the AMF. The GUAMI may be a concatenation of the PLMN ID and the AMF identifier.

In accordance with some embodiments of this disclosure, multi universal subscribed identity module (MUSIM) operation is provided as follows.

In certain representative embodiments, a UE may have multiple USIMs that may be in operation at the same time, where each USIM allows the UE to obtain service from a different mobile network. A typical use case for MUSIM devices may be for professionals who needed a business number and a separate personal number. Instead of carrying two phones, these professionals may use a single phone with two USIM cards.

In certain representative embodiments, the terminal behavior with respect to the simultaneous handling of multiple USIMs may depend on the UE capabilities (e.g. UE with single Rx/single Tx vs UE with dual Rx/single Tx vs UE with dual Rx/dual Tx), wherein dual Rx may allows a MUSIM UE to simultaneously receive traffic from two networks, single RX allows MUSIM UE to receive traffic from one network at one time, and single Tx allows MUSIM UE to transmit traffic to one network at one time.

In certain representative embodiments, the two USIMs may run independently of each other. Each USIM may need that the UE have a dedicated Non-Access Stratum and Access Stratum protocol stacks. However, depending on the capabilities of the UE, some coordination may be needed to allow the UE to obtain service to both mobile networks. In certain representative embodiments, this coordination may not rely on mobile network interactions. As a result, the UE acts like a mediator between the two mobile networks.

In certain representative embodiments, subscriptions may be designated to two network operators through a MUSIM device as a “dual subscription”, while each distinct subscription is designated to a network operator, not involving a MUSIM device, as a “single subscription”.

In certain representative embodiments, a AMF may use the N14 interface for AMF re-allocation and AMF to AMF information transfer. This interface may be either intra-PLMN or inter-PLMN (e.g., in the case of inter-PLMN mobility).

At inter PLMN mobility, the source AMF may select an AMF instance(s) in the target PLMN by querying target PLMN level NRF via the source PLMN level NRF with target PLMN ID. The target PLMN level NRF may return an AMF instance address based on the target operator configuration. After the Handover procedure the AMF may select a different AMF.

In accordance with some embodiments of this disclosure, DualSteer device architectures are provided as follows.

3GPP has, since the 4G protocol, supported a plethora of mechanisms that enable traffic steering, switching and splitting between a 3GPP access network (e.g., E-UTRA or NR) and a non-3GPP access network (e.g., WiFi). The most recent such mechanism is ATSSS feature supported since R16. More recently, new mechanisms are desired to support traffic steering and switching over two 3GPP access networks.

In certain representative embodiments, a DualSteer architecture may be based on providing a common anchor (UPF) and session management function (SMF) inside the 5GC for the DS traffic from both 3GPP access networks.

FIG. 2 illustrates a non-roaming dual steering architecture according to one or more embodiment of this disclosure. This architecture may allow a DualSteer (DS) device (e.g., any suitable WTRU 102) with DualSteer capability to connect to two separate 3GPP access networks simultaneously. The DS device establishes PDU sessions, each associated with a different access network. Two separate Access and Mobility Management Functions (AMFs) manage the mobility and session context for the DS device on their respective networks. A single Session Management Function (SMF) controls the overall PDU sessions and traffic steering for the DS device across both access networks. User plane data is anchored at a User Plane Function (UPF), which routes traffic between the data network and the DS device through one or both access networks as directed by the SMF.

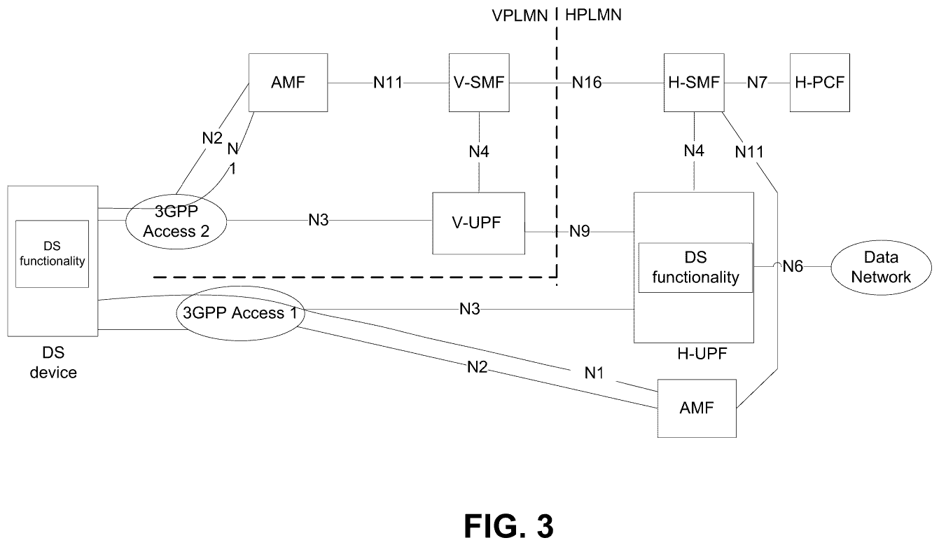

FIG. 3 illustrates a Dual steering architecture with roaming in one access according to one or more embodiment. The DS device with DualSteer functionality establishes connections with two distinct networks: the home public land mobile network (HPLMN) through 3GPP Access 1 and a visited public land mobile network (VPLMN) through 3GPP Access 2.

In the VPLMN, the DS device connects to a first AMF. User plane data is anchored at two UPFs: the V-UPF in the VPLMN and the H-UPF in the HPLMN. Traffic is routed between the DS device and the data network through either or both UPFs as directed by the SMFs.

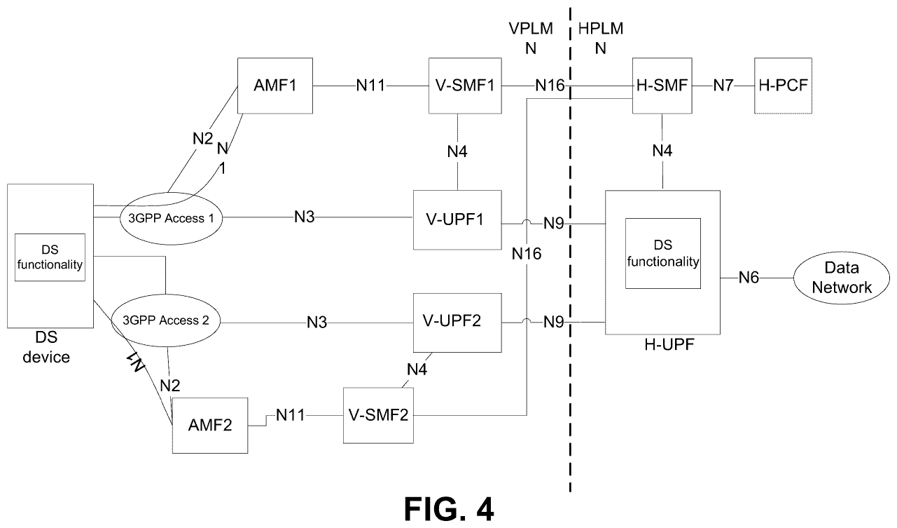

FIG. 4 illustrates a Dual steering architecture with roaming in both accesses with common VPLMN according to one or more embodiment. The DS device with DualSteer functionality establishes connections with two distinct 3GPP access networks (3GPP Access 1 and 3GPP Access 2) in the same VPLMN. Two separate AMFs manage the mobility and session context for the DS device on their respective access networks (AMF1 for 3GPP Access 1, AMF2 for 3GPP Access 2). User plane data is anchored at two V-UPFs (V-UPF1 and V-UPF2) located in the VPLMN and one H-UPF located in the HPLMN. Traffic is routed between the UE and the data network through any of these UPFs as directed by the SMFs.

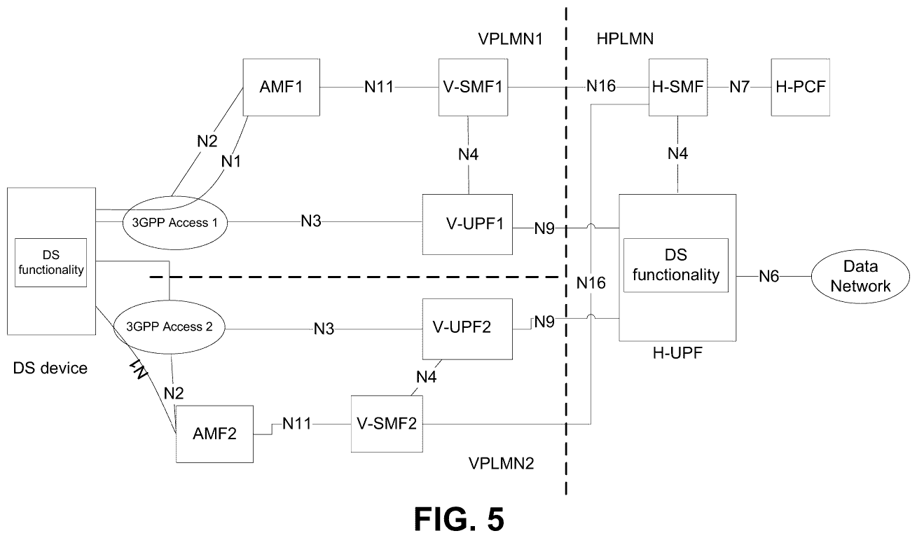

FIG. 5 illustrates Dual steering architecture with roaming in both accesses with two different VPLMNs according to one or more embodiment. The DS device establishes connections with two distinct 3GPP access networks (3GPP Access 1 in VPLMN1 and 3GPP Access 2 in VPLMN2).

Each VPLMN has its dedicated Access and Mobility Management Function (AMF) and Session Management Function (V-SMF), responsible for managing UE's mobility and session context in their respective networks. Traffic flows between the DS device and the Data Network through either V-UPF or H-UPF as directed by the SMFs.

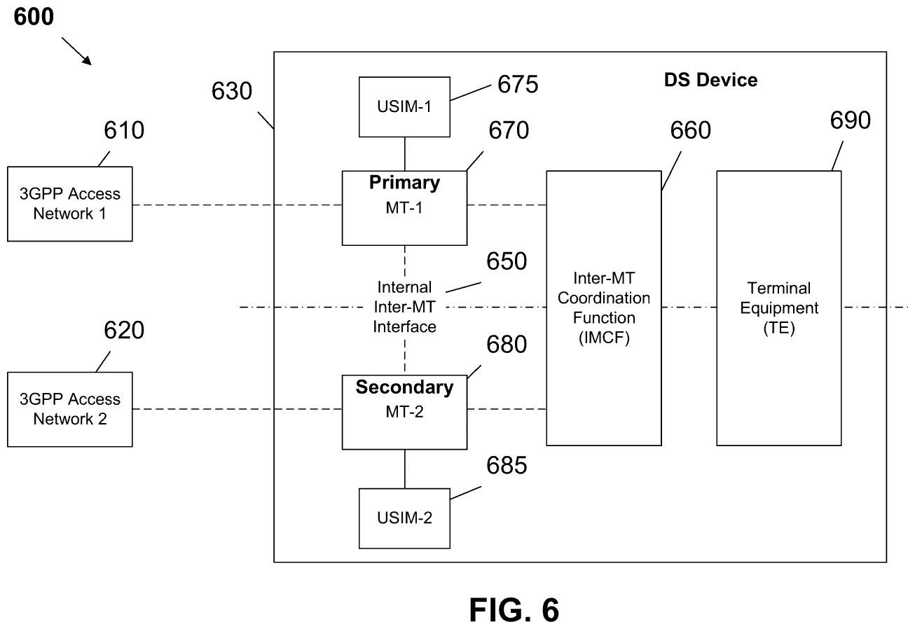

A DS device (e.g., any suitable WTRU 102) may be a Dual-MT (e.g., Dual-UE) device which may simultaneously connect to two 3GPP access legs. FIG. 6 illustrates an exemplary system 600 according to one or more embodiments of this disclosure, including DS device 630. The DualSteer device 630 may be any suitable WTRU 102 of FIG. 1B that has DualSteer capabilities. In certain representative embodiments, a WTRU may have two separate mobile terminations (MTs) and USIMs. For example, each MT may provide one or more functionalities of a MT (e.g., at least one of radio transmission, radio reception, baseband signal processing, access to USIM, access to CP stack, access to UP stack, combinations of the same, or the like) that is in a traditional UE. One MT may be considered a primary MT, while the other MT may be considered a secondary MT. A common Terminal Equipment (TE) may be provided (as shown, for example, in FIG. 6). In certain representative embodiments, two separate TEs corresponding to two MTs may be provided. An internal inter-MT interface between two MTs may be provided. The internal inter-MT interface may be configured to allow two MTs to exchange information. In certain representative embodiments, two MTs may exchange information through a higher layer “Inter-MT Coordination Function (IMCF)”. Two MTs may be identified by two unique device identifiers such as IMEIs. An additional ID called DualSteer specific UE ID (DS-specific-UE-ID) may be used to interlink the Primary and Secondary MT in a DualSteer or Dual-MT device.

In certain representative embodiments, as illustrated in the example of FIG. 6, a system 600 is provided. The system 600 may include a DualSteer device 630 configured to communicate with a first 3GPP access network 610 and/or a second 3GPP access network 620. The DualSteer device 630 may include a first or primary MT 670 and a second or secondary MT 680. The first or primary MT 670 and the second or secondary MT 680 may communicate, e.g., via an internal inter-MT interface 650. The first or primary MT 670 may have a first USIM 675. The second or secondary MT 680 may have a second USIM 685.

For example, an Inter-MT Coordination Function (IMCF) 660 may be provided. The IMCF 660 may be provided in the higher layer. The IMCF 660 may be part of a TE 690. The communication between MTs or between the MT and the IMCF 660 may use AT commands. Two MTs may be identified by two unique device identifiers such as International Mobile Equipment Identities (IMEIs).

Both MTs (which may correspond to two respective UEs) may have a separate subscription for registering to mobile network. Primary MT may register to a PLMN at first, and the Secondary MT 680 may register only when it is triggered by the Primary MT directly or via the IMCF layer 660. In accordance with some embodiments of this disclosure, an MT in a DualSteer capable WTRU may include the information of the primary or secondary MT (or UE) as part of its registration request message and send it to the network.

In connection with FIG. 6, a UE may be a device that includes an MT (e.g., primary MT 670 and secondary MT 680) and a USIM (e.g., USIM-1 or USIM-2), insofar as each MT may provide communication functionalities based on a registration using the USIM. For example, primary MT 670 and USIM-1 675 may be a primary UE, and secondary MT 680 and USIM-2 685 may be a secondary UE.

A DualSteer device 630, which may also be referred to as a Dual-UE or Dual-MT device, is capable of connecting to two 3GPP access legs, and to apply DualSteer functionality to switch, steer, split, or duplicate traffic across the two 3GPP access legs.

In accordance with some embodiments of this disclosure, additional DualSteer device capabilities are provided as follows.

In certain representative embodiments, a DualSteer Device may support traffic steering and switching of user data (for different services) across two 3GPP access networks. A DualSteer device may send its user data over two 3GPP access networks belonging to the same PLMN or different PMLN, either simultaneously or non-simultaneously.

In certain representative embodiments, a DualSteer device may have two separate UEs or mobile terminals (MTs) with individual USIM (two SUPIs), with each MT providing functionalities that are in a MT of a traditional UE, such as radio transmission/reception, baseband signal processing, access to USIM, CP/UP stacks, etc. These two separate MTs may be termed as primary and secondary MTs within the DualSteer device (Dual-MT Capable device). Primary and secondary UEs may have different capabilities, e.g., the primary UE may act like a normal UE whereas the secondary UE may have limited capabilities.

In certain representative embodiments, two USIMs in a DualSteer device may be co-located and there may be an association between the 2 SUPIs for the DualSteer device, e.g., DS-specific-UE-ID. The two UEs may be either in the same DualSteer device or they may be in close proximity (e.g., a few meters apart, or otherwise within the same wireless cell or general geographical location) and thus they may be linked (e.g., as a logical device) as belonging to the same DualSteer device. Both UEs may connect to the same PLMN or to the two different PLMNs. For mobility registration update or periodic registration update, both UEs may require a registration update, e.g. if the registration area changes, or if a time duration of association has expired. If the registration update due to mobility or periodic timer is separately performed at both UEs, it may increase signaling overhead. In certain representative embodiments, both UEs may not always be active, both may not have simultaneous traffic, e.g., when one UE is the primary and the other is only for the back-up to switch traffic. In such scenarios uncoordinated or unsynchronized registration update for both UEs may waste computational resources. Reduction on signaling by leveraging the fact that the two UEs are in the same DualSteer device (e.g., and can share association information between each other) may greatly impact the performance.

In certain representative embodiments, the control plane signaling for a DualSteer device may be optimized for different procedures.

In certain representative embodiments, the different procedures may include, e.g., registration and mobility management, service request and UE configuration update.

In certain representative embodiments, a DualSteer capable device with two UEs includes one of the two being designated as a primary UE and the other being designated as a secondary UE. Designation of a primary UE and a secondary UE may be permanent, or it may be temporary and/or dynamic based on the steering modes. One of the UEs, e.g., primary UE, may have full capability (for example it may behave as a standard cell phone), while the other UE, e.g., secondary UE, may have limited capability.

In certain representative embodiments, a common identifier called DualSteer specific UE ID, e.g., DS-specific-UE-ID, Common PDU session ID or any other suitable association information, may be used to interlink the primary and secondary UEs at initial registration or PDU session establishment to network and to associate their PDU sessions. The DualSteer specific UE ID (i.e., the DS-specific-UE-ID) may be derived at the Inter-MT coordination function (IMCF) layer (e.g., for sharing association information between the primary, or first, and secondary, or second, UEs) based on the application or service being used, and it may be provided to the UEs. Moreover, this ID may be configured by a network function (NF) (e.g. AMF or policy control function (PCF)) during a Mobility Registration procedure, it may be configured at either of the primary/secondary UE and exchanged internally, or it may be pre-configured in the DualSteer capable devices. This configured ID may be provided by an application in the UE or an application server over the application layer (e.g., the user plane).

In certain representative embodiments, a DualSteer device may have only a primary UE registered to the network, and a secondary UE registration is triggered based on an internal trigger, for example, when a PDU session establishment for the secondary UE is desired so that traffic needs to be switched from primary to the secondary. In certain representative embodiments, both UEs may have registered to the network but only the primary UE may be active, and the secondary UE may be idle while waiting for a trigger from the primary UE (e.g., where this trigger may include sharing association information, e.g., as received from the wireless network). It may also be possible that both UEs perform simultaneous registration. In any of the aforementioned cases, both of the UEs may use the association information (e.g., the common ID, e.g., the DS-specific-UE-ID), so that the network can identify the UEs as being linked to a DualSteer-capable device and can authorize the device for performing DualSteer functions based on the UEs.

In certain representative embodiments, a method of signaling reduction for DualSteer devices is provided. The signaling reduction may be enabled by indicating signaling reduction (SRD) capability using SRD indication. An SRD indication may be provided by the DualSteer devices to the network, e.g., upon registration. If the network supports SRD for DualSteer devices, then upon reception of SRD indication it may enable the coordinated and/or synchronized control plane signaling between the two UEs to reduce or optimize the signaling for the secondary UE in a DualSteer device. Alternatively, the SRD capability may be part of the device subscription information associated with the device. This capability may be stored in a Unified Data Management (UDM) and retrieved during registration procedure or PDU session establishment.

In certain representative embodiments, a UE in a DualSteer device that is SRD capable may send an SRD indication to the PLMN upon initial registration, at mobility or periodic registration update, service request, PDU session establishment or via other NAS control plane signaling procedures.

In certain representative embodiments, a PLMN may support SRD or not, and for DualSteer device case it may depend on the serving PLMNs of the two UEs, e.g., PLMN 1 may support SRD with PLMN 2 but not with PLMN 3. If the secondary UE registers to PLMN2, it may provide information about PLMN1 together with SRD indication. AMF2 may check its configuration and may determine if SRD is supported with PLMN1. AMF2 may reply with an SRD indication ack, which may be used by the UE to determine if SRD will be used or not.

In certain representative embodiments, when the primary UE registers with PLMN1 and indicates its SRD capability, AMF1 may provide a list of PLMNs that will support SRD with PLMN1. This list of PLMN may be shared with the secondary UE and may be used by the secondary UE for PLMN selection.

In certain representative embodiments, it may be assumed that the primary UE is always performing the updates for both UEs or triggers the secondary UE to perform any updates. However, in certain representative embodiments, it may be either of the two UEs based on link quality, network load, configurations or their capabilities. In certain representative embodiments, there may be a logic at the DualSteer device or at the network, to decide who is going to perform update for a given service, e.g., there may be a scenario where primary is in an active session while the secondary is idle and being dual TX/RX UE. It may be the secondary UE who gets triggered.

In certain representative embodiments, e.g. network triggered service request procedure, SRD may be triggered by the network given the network is aware of SRD capability of a DualSteer device.

In accordance with some embodiments of this disclosure, access network association approaches are provided as follows.

Some approaches address aspects of associating SUPIs of 3GPP legs associated with a DualSteer device. These approaches rely upon the association of SUPIs by the UDM through generation of SUPI association information if the SUPIs belong to a DualSteer subscription. In a first approach, primary and secondary roles associated with UEs are considered, and a primary UE is registered before other secondary UEs are registered. In a second approach, the UDM generates a correlation_ID and provides it to UE-1. UE-2 uses the received correlation_ID when registering, which is in turned used by the UDM for associating UE-1 with UE-2.

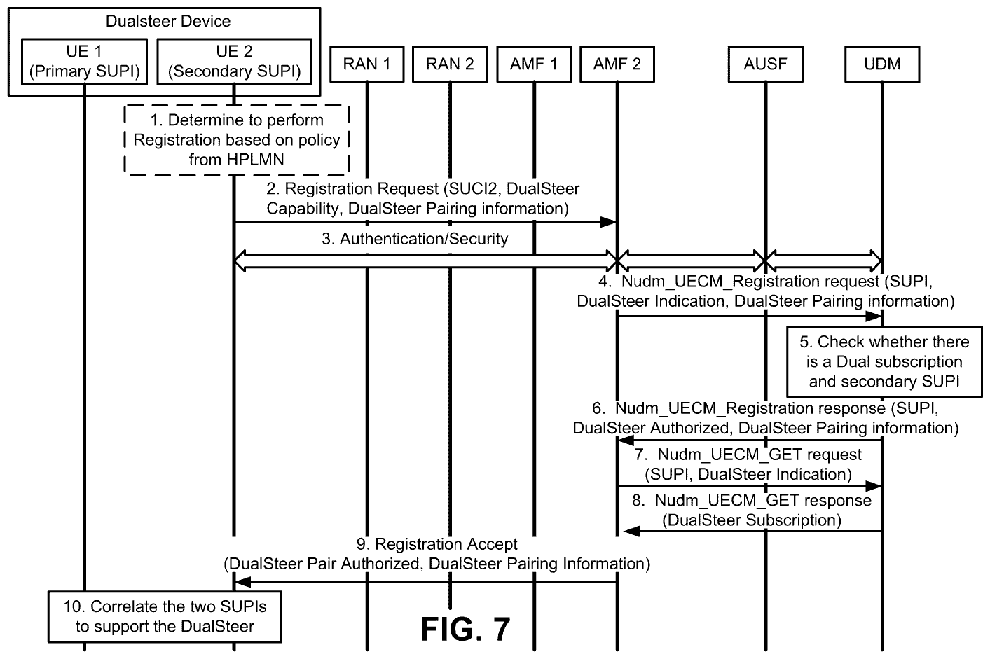

FIG. 7 is an illustrative diagram demonstrating an approach for registration of a secondary SUPI. Certain steps of the method shown in FIG. 7 are described in more detail as follows.

As shown in step 5 of FIG. 7, the UDM may check whether the SUPI is associated with the DualSteer subscription. Based on determining that the SUPI is a secondary SUPI, and that the primary SUPI has not been registered, the UDM may reject the registration request based on policy (e.g., the secondary SUPI can only be used concurrently with the primary SUPI). At step 6, the UDM may check that the DualSteer Pairing information received from the AMF (e.g., AMF-2) at step 4 is the same as the one allocated to the other associated SUPI and inform the AMF (e.g., AMF-2). At step 8, the UDM may indicate to the AMF (e.g., AMF-2) that the SUPI provided in the registration request is a secondary SUPI associated with a DualSteer subscription. At step 9, the AMF (e.g., AMF-2) may inform the UE (e.g., UE-2) that the registration has been accepted, e.g., the message including an indication that the DualSteer pair has been authorized, the DualSteer pairing information, and the secondary SUPI indication. At step 10, the DualSteer Device may correlate the two SUPIs to support the DualSteer functionality based on the DualSteer pair authorized result and the DualSteer pairing information.

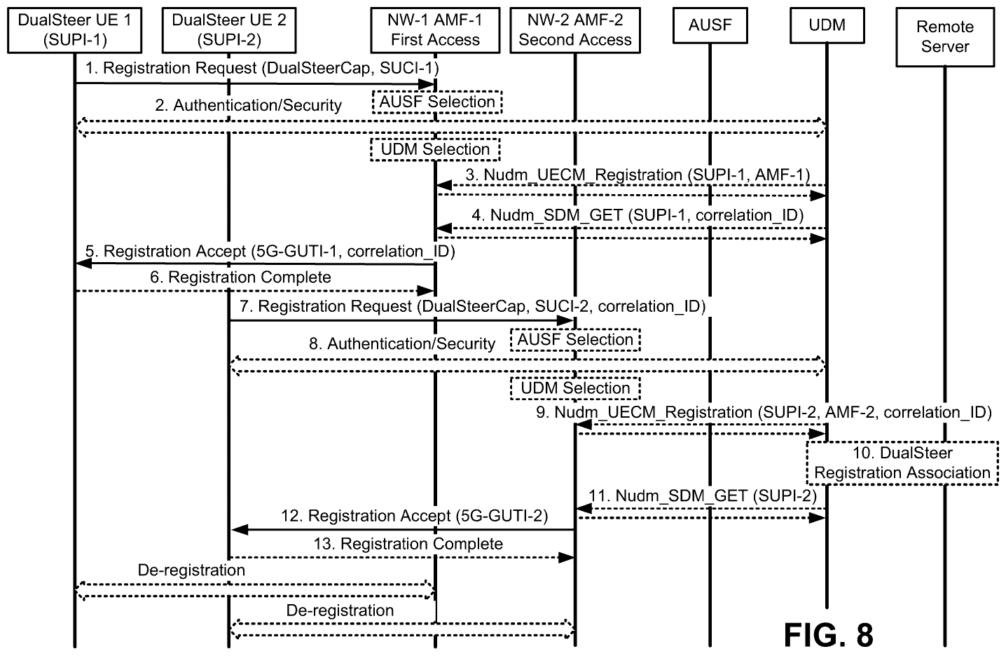

FIG. 8 is an illustrative diagram demonstrating an approach for registration, paging, and de-registration of a DualSteer device. Certain steps of the method shown in FIG. 8 are described in more detail as follows.

As shown in steps 3-4 of FIG. 8, in some approaches, the UDM allocates a correlation_ID for the SUPI-1 and returns it to AMF-1 with the subscription data in the Nudm_SDM_GET response. As indicated in step 7, the UE-2 may send a registration request to the NW-2 (e.g., AMF-2 of NW-2) including a correlation_ID, which may allow the UDM to tie the two DualSteer registrations together. As shown in steps 12-13, the AMF (e.g., AMF-2 of NW-2) may notify the UE (e.g., UE-2) that the network supports DualSteer, that the device has a DualSteer subscription, and/or that the DualSteer registration has been activated.

Such approaches also provide for the de-registration of a UE (e.g., UE-1 and/or UE-2), which may be initiated by the respective UE or the network. The UE or network may de-register the access in any order (e.g., de-registration of UE-1 before UE-2, de-registration of UE-2 before UE-1). Based on de-registration of one of the access networks (e.g., first access NW-1), the UE may cease operation as a DualSteer device and the registration for the remaining access network may operate similar to that of a UE with single access registration.

In accordance with some embodiments of this disclosure, illustrative instances for associating multiple USIMs with a DualSteer device are provided as follows.

A DualSteer Device may consist of a single (e.g., physical or logical) device with multiple access legs and one or more removable USIMs. For example, a physical DualSteer device may have two UEs (each having a respective USIM) that are co-located in the same physical device. This device may be associated with DualSteer services that require both USIMs to be deployed and associated with the same physical DualSteer device. In another example, a logical DualSteer device may be an association of two physically separated UEs., e.g., associated with DualSteer services that do not require both USIMs to be deployed in the same physical DualSteer device. A USIM may be designated as a primary USIM while another (e.g., co-located or physically separated) USIM is referred to as a secondary USIM. This role may be designated based on whether the USIM is used with the primary MT or the secondary MT. In some cases, the role of the USIM (e.g., primary, secondary) may be interchanged.

In some approaches, the secondary USIM is only used when necessary, for example for DualSteer functions. The exemplary usage scenarios of the secondary USIM are described as follows. Any one or more of these examples may be a trigger to associate the first USIM and the second USIM with the WTRU. In one example, a user only has a single registered USIM in a device and inserts a second DualSteer-enabled USIM into the device. In another example, a user has two USIMs registered for using DualSteer capabilities. One USIM is associated with the primary access leg, USIM, UE, and/or MT component, and the second USIM is associated with the secondary access leg, USIM, UE, and/or MT component. In this example, the user removes the second (e.g., secondary) USIM. In another example, the user with two USIMs registered for using DualSteer capabilities removes the first (e.g., primary) USIM. In response to the removal of the first USIM (e.g., previously the primary USIM), the second USIM (e.g., secondary USIM) may become the primary USIM (e.g., associated with the primary access leg, USIM, UE, and/or MT component). In another example, a user has two USIMs. However, the user only has a USIM that is associated with the secondary access leg, USIM, UE, and/or MT component inserted and registered for using DualSteer capabilities. In this example, the user inserts the USIM associated with the primary access (e.g., leg, USIM, UE, MT) component.

In some embodiments, instead of USIMs, the device may support eSIM (embedded subscriber identity module) capabilities. Therefore, there may be devices that support one or more eSIMs, or a combination of USIMs and eSIMs. Instead of inserting or removing physical SIM cards, the eSIM capability may be enabled, configured, and/or disabled by the user or by an application. Throughout this disclosure, SIM, UICC, USIM, eSIM are used interchangeably.

Certain DualSteer capabilities may be used only if the two USIMs are associated with UEs that are in the same physical DualSteer device. For example, in scenarios where steering (e.g., selection of the most suitable network) and splitting (e.g., network aggregation) functionalities and/or services are used, the UEs must physically be co-located within a single device. In contrast, switching (e.g., seamless handover between access legs) may be performed by a physical DualSteer device where both UEs are housed on the same physical DualSteer device, or by a logical DualSteer device where the two UEs are separate physical UEs.

Current approaches that support MUSIM devices (e.g., devices with multiple USIMs), may treat each of the USIMs independently and may not check if the two USIMs are in UEs that are physically co-located. DualSteer devices relying on these approaches may experience error conditions at the UE. For example, the network may send DualSteer rules to a UE that is not capable of using these rules. In some cases, a 3GPP system should ensure that USIMs that are associated with the multiple access legs belong to the same DualSteer device.

In addition, the current approaches that support MUSIM devices (e.g., devices with multiple USIMs) treat each of the USIMs independently. In these approaches, when one of the USIMs is removed, there is very limited impact on the operation of the UE using the other USIM. DualSteer devices relying on these approaches may also experience error conditions at the UE. For example, in situations where a USIM that is associated with an access leg with PDU sessions is removed and/or deregistered, the device is unable to manage the traffic that belongs to these PDU sessions. Therefore, in some cases, a 3GPP system capable of managing such PDU sessions is beneficial.

Herein, we present procedures related to associating multiple access legs, UEs, or MT components, with a single DualSteer or MultiSteer device.

The multiple access legs may be used for simultaneous transmission as well as traffic steering, switching, and splitting, depending on the deployment or application scenario.

A DualSteer device may be a physical device that hosts multiple UEs, with each UE is associated with an access leg. Alternatively, a DualSteer device may be a logical device with multiple associated, but physically separate, physical UEs, where each physical UE is associated with an access leg. In this disclosure, we use the term DualSteer device as an example of any such device or WTRU. However, the subject matter described herein may be of relevance to other scenarios, such as, MultiSteer devices where multiple access legs (e.g., more than two access legs) are associated with the same device.

In this disclosure, we discuss two access legs used by a single DualSteer device. In some embodiments, the DualSteer device architectures may vary, dictating how components within the DualSteer device are designed, and consequently, how the access networks that are established are associated to the DualSteer device. In one example, the two access legs are associated with two UEs. In another example, the two access legs are associated with two MT components. Herein, we use the terms access legs, access networks, UEs, and MT components interchangeably.

In accordance with some embodiments of this disclosure, illustrative methods and systems for associating multiple USIMs with a DualSteer Device are provided as follows.

A first scenario may be provided for cases where the DualSteer device is aware of the UEs to be used in the DualSteer session. In the first scenario (e.g., scenario A), USIM association gets triggered at the DualSteer device. A first UE (e.g., UE-1) may send a first message including a registration request or a registration update request to the network (e.g., AMF). This first message may include DualSteer capabilities that may be used (e.g., switching, steering, and splitting) with a second UE (e.g., UE-2) and may specify whether the registering UE (e.g., UE-1) is a primary or a secondary UE. UE-1 may receive a second message including a registration update/request response from the network (e.g., AMF), where the second message may include authorized DualSteer capabilities as well as UE/USIM association information. The UE-1 may provide the received association information and information of authorized DualSteer capabilities in a third message that is sent to UE-2. UE-2 may send a fourth message to the network (e.g., to the AMF) including a registration update/request. This fourth message contains the UE/USIM association information that may be received from UE-1. UE-2 may receive a fifth message including a response to the registration, registration update, or UE association request, which may include one or more of the following: DualSteer/ATSSS capabilities authorized, UE association information, or the time duration of validity for the association ID and/or the association itself. The DualSteer device may then update its registration status and perform DualSteer functions based on the time duration and on the authorized DualSteer capabilities.

In the first scenario (e.g., scenario A), a NF (e.g., AMF, UDM, and PCF) of the network receives the UE-1 information, USIM1 information, DualSteer information, and subscription information from UE-1, and checks whether the requested DualSteer/ATSSS capabilities can be used by the UE, additionally acquiring the locality of the UEs. The network may generate association information, which may include an association ID for the UE-1 USIM (e.g., USIM1). The network may also provide the association information to UE-1 from the corresponding AMF along with subscription data. The network may also send a registration update and/or request response to UE-1, which may specify authorized DualSteer capabilities and include UE/USIM association information. The network may receive a registration update and/or request from UE-2 including one or more of UE-2 information, USIM2 information, DualSteer information (e.g., capabilities), or subscription information along with association information. The network and/or the WTRU may check whether the association information received from UE-2 is consistent with the association information generated for UE-1, whether the received USIM information is associated with a DualSteer subscription, and whether UE-2 is authorized to be associated with the DualSteer device. In such a scenario, the network can ensure that the requested DualSteer/ATSSS capabilities can be used by the UE-2 along with the UE-1, taking into consideration subscription, policy (e.g., from PCF) and locality information. Based on this review, the network may update the subscription/association information to include details of the UE-2.

A second scenario may be provided for cases where the network asks the device to determine which UEs to use for the DualSteer session. In the second scenario (e.g., scenario B), the USIM association also gets triggered at the DualSteer device. However, in this scenario, UE-2 sends a first message to the network (e.g., to the AMF) including a registration and/or registration update request, where the first message may include DualSteer capabilities to be used with UE-1 (e.g., ATSSS capabilities including switching, steering, and splitting), UE-1 information (e.g., UE-1 IMEI) and an indication of whether the registering UE (e.g., UE-2) is a primary or a secondary UE. In response, UE-1 may receive a second message including a registration update/de-registration request from the network (e.g., AMF). This second message may specify that UE-2 is attempting to register with the network to be part of the DualSteer device and may include UE/USIM information of UE-2. In response, UE-1 may send a third message to the network (e.g., to the AMF) including registration update and/or a registration request, including DualSteer capability information and the association information received from the network. This request may specify if the registering UE (e.g., UE-2) is a primary or a secondary UE. Both UE-1 and UE-2 may receive respective responses (e.g., fourth and fifth messages) including their respective registration statuses. In response, UE-1 and UE-2 may update their registration statuses accordingly, and the WTRU may perform DualSteer capabilities based on the updated registration statues.

In the second scenario (e.g., scenario B), a NF (e.g., AMF, UDM, and PCF) of the network receives UE-2/USIM2 information from UE-2 and checks whether this UE-2/USIM2 information is associated with a DualSteer subscription and can be associated to a DualSteer device. The network may communicate with a database that stores information of UEs/USIMs to determine whether there are UEs that can be associated with UE-2. The network may select one or more UEs (e.g., UE-1) to associating with UE-2. The network may additionally ensure that the requested DualSteer/ATSSS capabilities can be used by the UE-2 and UE-1. The network may generate association information to be used for associating (e.g., only) UE-2 with UE-1 in the future, which may include an association ID. The network may send UE-1 a registration update/de-registration request, e.g., including UE/USIM information of UE-2 and an indication that UE-2 is attempting to register with the network to be part of the DualSteer device. The network may receive a registration update/request message with one or more of UE-1, USIM1, DualSteer, subscription, or association information. The network may check whether this USIM1 information is associated with UE-2 and a DualSteer subscription and based on the result, provide the authorization information to the corresponding AMF. The network may send responses to the registration requests received from UE-1 and UE-2. The responses may include DualSteer association information.

In some embodiments, a UE (e.g., UE-1) may initiate a disassociation process based on the lapsing of an indicated time duration, or based on the occurrence of a disassociation trigger. In one example, UE-1 sends a deregistration request to the network (e.g., AMF), including any combination of association information. The deregistration request may include an indication of what to do with the associated UEs (e.g., other associated UEs deregistered/terminated at the same time) and/or an indication of how to handle disassociations of associated UEs. UE-1 may receive a deregistration accept message from the network, which may indicate how existing traffic is handled (e.g., drop all QoS flows). UE-1 may notify associated UEs about the deregistration (e.g., through the DualSteer layer) and associated UEs (e.g., UE-2) may deregister with the network.

In some embodiments, a NF (e.g., AMF, UDM, and PCF) of the network receives the deregistration request from a UE (e.g., UE-1), including any combination of association information. The deregistration request may include an indication of what to do with the associated UEs (e.g., other associated UEs deregistered/terminated at the same time) and/or an indication of how to handle disassociations of associated UEs. The network may determine how to handle any existing sessions and flows of the deregistering UE (e.g., UE-1). In one example, the network determines one or more of the following: sessions and/or flows are to be transferred to an associated UE, all sessions are to be terminated, or existing traffic is handled based on policy information received from a PCF. The network may send a deregistration accept message to the UE (e.g., UE-1), which may indicate how existing traffic is handled (e.g., drop all QoS flows).

For illustration purposes, the figures and described procedures herein may combine the AMF serving UE-1 and the AMF serving UE-2 into a single logical AMF block. In embodiments, where the AMFs serving the UEs are distinct, the messages may be sent between the corresponding AMF and UE pair (e.g., messages are sent between UE-1 and AMF-1, as well as UE-2 and AMF-2).

In accordance with some embodiments of this disclosure, illustrative USIM association triggers are provided as follows.

In some embodiments, UE/USIM and/or access leg association may be triggered at the DualSteer device by an association trigger, which may comprise one or more of the events listed as follows: inserting of a second USIM (e.g., into UE-2); inserting of a first USIM (e.g., into UE-1); enabling of an eSIM, e.g., including the reception of eSIM configuration or reconfiguration; powering on the DualSteer device; powering on any associated UEs; receiving a request from the application layer or higher layers (e.g., starting an application that requires DualSteer functionality); receiving a request from the Inter-MT coordination function (IMCF); receiving a request from the 3GPP network (e.g., through a NAS message); or receiving a request from a user, through a graphical user interface.

The association trigger may be based on policy information received from the network (e.g., PCC rules) and trigger the association based on any combination of the following: time value (e.g., specified as timer value, time window, periodic check, absolute time); location information (e.g., when the user is at work); network characteristics (e.g., network conditions); or UE characteristics (e.g., battery consumption, QoE, QoS).

In accordance with some embodiments of this disclosure, illustrative USIM disassociation triggers are provided as follows.

In some embodiments, the DualSteer device is triggered to perform a USIM disassociation procedure based on detection of a disassociation trigger. Disassociation may be triggered by one or more of the following events for a DualSteer device with an established association: removing a second USIM (e.g., from UE-2); removing a first USIM (e.g., from UE-1); disabling an eSIM; powering off the DualSteer device; powering off any associated UEs; receiving a request from the application layer/higher layers; receiving a request from the IMCF; receiving a request from the 3GPP network (e.g., through a NAS message); or receiving a request from a user, through a graphical user interface.

The disassociation trigger may be based on policy information received from the network (e.g., PCC rules) and trigger the disassociation based on any combination of the following: time value (e.g., specified as timer value, time window, periodic check, absolute time); location information (e.g., when the user is at work); network characteristics (e.g., network conditions); or UE characteristics (e.g., battery consumption, QoE, QoS). In one example, the disassociation procedure is triggered based on a loss of coverage on the primary or secondary leg, e.g., triggered based on the expiration of an associated timer. In another example, the disassociation triggers based on fatal rejection from the network on the primary or secondary leg, e.g., GPRS services are not allowed, N1 mode is not allowed. In another example, disassociation is triggered based on PLMN selection on the primary or secondary leg that leads to network selection that does not support DualSteer (e.g., or MultiSteer) functionality.

In one example, the DualSteer device receives a request from the 3GPP network based on the CN or RAN detecting and determining that the existing DualSteer associations should be terminated (e.g., due to congestion or resource optimization). In this example, the network may inform the UE of the deregistration through a NAS message (e.g., deregistration message).

In accordance with some embodiments of this disclosure, illustrative procedures for authorization and association of access legs, UEs and MTs are provided as follows.

In some embodiments a SIM association procedure is used to associate one or more access legs (e.g., and their constituting components) to a single DualSteer device. Information used for authorization and/or association (e.g., the association information) may include one or more of the following: USIM information, e.g., integrated circuit card identification (ICCID), international mobile subscriber identity (IMSI); UE information, e.g., an IMEI as a new UE identifier; device information, e.g., an IMEI as a new device identifier; subscription information, e.g., IMSI, SUPI; or other security authentication and ciphering information. For example, the security authentication and ciphering information may include a hash of any one or more of the aforementioned examples of suitable association information.

In some embodiments, the association information includes an association ID that is generated (e.g., by the WTRU, or by the wireless network) to identify the association established by the SIM association procedure. The association ID may be created as a function of one or more of the following: USIM information, e.g., ICCID, IMSI; UE information, e.g., IMEI, a new UE identifier; device information, e.g., IMEI, a new device identifier; subscription information, e.g., IMSI, SUPI; or other security authentication and ciphering information.

The association information (e.g., the association ID) may be used to ensure that the associated access legs, UEs, and/or MTs, belong to the same DualSteer device (e.g., physical or logical), are physically co-located on the same physical DualSteer device, and/or are associated with a DualSteer enabled subscription.

In some embodiments, a database stores UE/USIM and DualSteer information, which may be maintained in the network, e.g., by the device manufacturer and the operator. This database may contain information such as IMEIs of the UEs, e.g., additionally indicating IMEIs that are linked, physically co-located, and/or authorized to be used for DualSteer. This database may be part of the Equipment Identity Register (EIR). For example, a NF may use this database to query information (e.g., a locality) of UE-2 and its associated UEs when authorizing and associating UEs.

In some embodiments, the association information may be maintained in the UDM. The UDM may maintain the subscription information of both UEs in one subscription profile. The subscription information may include an association indication to indicate if the USIMs associated with the two subscriptions are in the same device. The association indication may be any one of: “yes-same physical device”, “yes-same logical device”, “no”, or “not verified”.

This association or subscription information may be updated and maintained in the UDM using the following mechanism. Upon any association trigger or dissociation trigger, the DualSteer device may send a NAS message to the network to inform the network about the associated UEs. For example, the DualSteer device may provide an indication of the IMEIs or SUPIs or SUCIs of the two UEs of the DualSteer device. The NAS message (e.g. Registration Request message, UL NAS message) may be sent by either UE. The IMCF may provide UE-2 information to UE-1. Upon reception of the NAS message, the subscription information in the UDM may be updated. For example, the UDM may receive a NAS message indicating that two subscriptions identified by SUPI1 and SUPI2 are from USIMs that are on the same physical device. The UDM may then change the association indication for the two subscriptions identified by SUPI1 and SUPI2, from “no” to “yes-same physical device”.

In some examples, the locality information of a UE is obtained through retrieving the location information (e.g. tracking area, cell) for each UE from the network. For example, a NF (e.g., UDM, AMF, EIR) verifies if a UE is within a certain geographical area based on the locality information. In other examples, UEs in same physical device share a common identifier. A NF (e.g., UDM, AMF, EIR) may compare identifiers of multiple UEs, and verify that the multiple UEs are physically co-located based on the determining that the identifiers match.

The authorization procedures may determine that access legs to be associated to the same DualSteer device can be associated based on the parameters described above and/or policy information received from a PCF. In some examples, policy dictates how and when association information may be used. For example, the policy may dictate when the association is valid. This policy information may be provided to the UEs during registration procedures (e.g., with a Registration Accept message). Alternatively, the policy information may be provided as part of the PCC rules. The policy information may indicate one or more of the following: a time value that indicates that an association is only valid at certain times (e.g., between 2 AM and 4 AM); a location value that indicates that an association is only valid for certain areas (e.g., defined by a geofence, list of cells, or list of tracking areas); or a service value indicating that the association can be established only when a particular service is active (e.g., a XR session is active, localized services are active).

In accordance with some embodiments of this disclosure, illustrative registration procedures are provided as follows for a DualSteer device (e.g., any WTRU 102 of FIGS. 1A-D) in connection with a wireless network (e.g., core network 106 of FIG. 1A and FIG. 1C, or core network 115 of FIG. 1D). In some embodiments, other NAS procedures (e.g., UE configuration update, UL/DL NAS Transport procedure etc.) can be used in place of registration procedures. The NF described herein may be an AMF, SMF, UDM or PCF. The NF may be an existing NF or it may be a new NF.

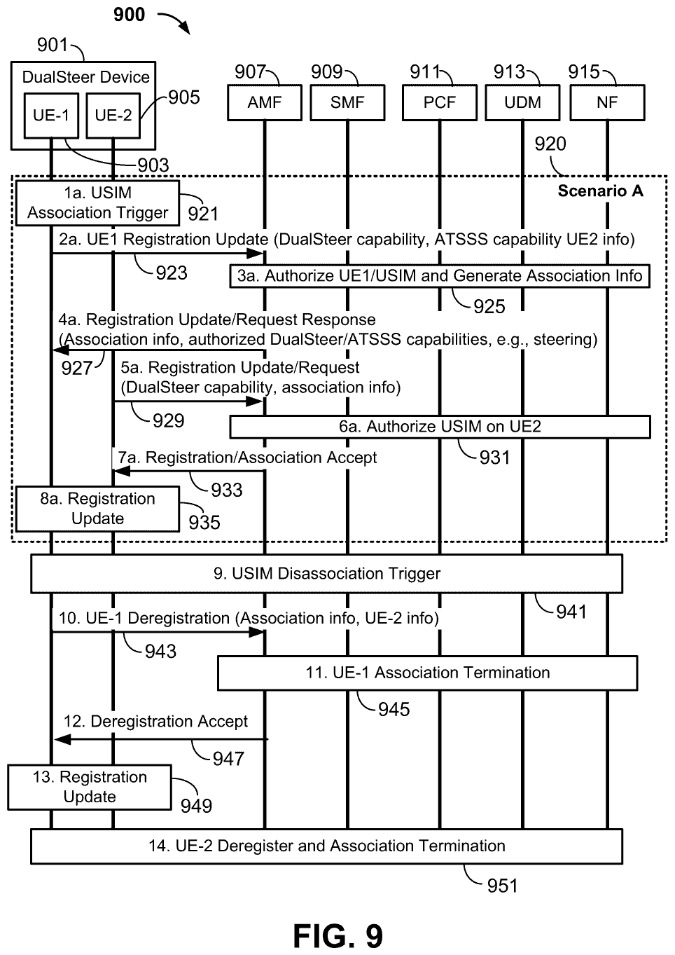

FIG. 9 shows an illustrative flowchart of a method 900 for executing a registration procedure for associating USIMs with the same DualSteer device. The method 900 is performed by DualSteer device 901 (e.g., any suitable WTRU 102), which includes UE-1 903 and UE-2 905, based on communications with a wireless network (e.g., including AMF 907, SMF 909, PCF 911, UDM 913, and NF 915). For ease of comprehension, both UEs are shown as registering to AMF 907. However, in some embodiments, respective UEs can register to different AMFs.

As shown in FIG. 9, in some embodiments, the DualSteer device 901 is aware that UE-1 903 and UE-2 905 are to be used in the DualSteer session and initiates a first registration procedure (e.g., Scenario A 920 of FIG. 9, consisting of steps 1a-8a). At step 1a 921, the USIM association may be triggered at the DualSteer Device 901 (e.g., by detection of one or more association triggers described above). In one example, the USIM information associated to UE-2 905 (e.g., USIM2 information), including DualSteer capability and subscription information, is provided to UE-1 903, e.g., through the DualSteer layer or IMCF (e.g., IMCF 660).

At step 2a 923, UE-1 903 may send a first message including a registration request and/or a registration update request. This request may specify DualSteer capabilities to be used with UE-2 905. For example, the request may specify ATSSS capabilities that may be used (e.g., switching, steering, and/or splitting). This request may specify if the registering UE (e.g., UE-1 903) is a primary or a secondary UE.

At step 3a 925, a NF 915 (e.g., which may coordinate with AMF 907, UDM 913 and/or PCF 911) may receive UE-1 903 information, USIM1 information, DualSteer information, and subscription information. The NF 915 (e.g., in coordination with UDM 913) may determine whether UE-1 903 is authorized to be associated with DualSteer device 901 based on checking whether the USIM1 information is associated with a DualSteer subscription. At step 3a 925, the NF 915 may additionally check if UE-1 903 is authorized to be associated with UE-2 905, as requested in step 2a 921. This step may be useful in scenarios where UE-1 903 may have more than one potential candidate UEs for association, allowing UE-1 903 to specify which UE it wants to be associated with in the registration request. In one example, an application or a service requests two UEs to be associated.

Step 3a 925 ensures that the requested DualSteer/ATSSS capabilities can be used by the UE. In one example, the NF 915 authorizes switching to be used by DualSteer devices with access legs that are associated with either a single physical DualSteer device with co-located UEs, or with multiple physical UEs that are associated with the same logical DualSteer device. However, in this example, the NF 915 only authorizes UE-1 903 to use steering and splitting functionalities based on UE-2 905 being physically co-located within the DualSteer device 901.

The NF 915 (e.g., in coordination with UDM 913) may generate association information (e.g., USIM information, UE information, Device information, Subscription information), to be used for associating another UE-2 905 with UE-1 903 in the future. This association information may include an association ID for UE-1 903 and corresponding USIM. The NF 915 may provide the association information to the corresponding AMF 907 along with subscription data. The association information may be used to derive or map, associated UEs, USIMs, and or MT components, the physical locality of said UEs, USIMs, and/or MT components, as well as subscriber information. For example, using the association ID, the NF 915 (e.g., in coordination with UDM 913) may be able to identify other UEs associated with DualSteer device 901. The association ID may consist of a hash function of UE info (e.g., IMEI), USIM info (e.g., ICCID, IMSI), and/or subscription info (e.g., IMSI, SUPI).

To enable cases where UE-1 903 and UE-2 905 are in connection with different networks (e.g., Network-1 and Network-2, respectively), Network-1 may digitally sign the association information (e.g., UE-1 and UE-2 IMEIs), and provide it back to UE-1 at step 4a. UE-2 may then provide the signed association information to Network-2 at step 5a 929. The signed association may include a time indication corresponding to a limited lifespan.

At step 4a 927, UE-1 903 (e.g., corresponding to USIM1) may receive a second message including a registration update/request response from the network (e.g., from AMF 907). This response may specify an acceptance, rejection, or partial acceptance of the registration request at step 2a 923. In one example, the network is unable to authorize DualSteer services and rejects the registration update/request. In another example, the network is also unable to authorize DualSteer services but accepts the registration update/request as a regular registration without DualSteer capabilities. The registration update/request response may include the UE/USIM association information generated in step 3a 925. In some examples, the association ID is a function of UE and/or subscription information and the UE generates the association ID using information available locally. In such examples, the network (e.g., UDM) does not need to communicate the new association ID to the UE. The registration update/request response may also include authorized DualSteer capabilities (e.g., steering) that may be used with another associated UE in the future. At step 4a 927, UE-1 903 may additionally provide, in a third message, the received association information and information of authorized DualSteer capabilities to UE-2 905 (e.g., through the DualSteer layer and/or IMCF 660).

At step 5a 929, UE-2 905 may send a fourth message including a registration update/request to the network (e.g., to AMF 907). In one example, at step 5a 929, UE-2 905 instead sends a new NAS message, e.g., a UE Association Request. In another example, the registration update/request contains the UE/USIM association information received by the UE-1 903 (e.g., association ID, DualSteer capabilities requested).

At step 6a 931, NF 915 (e.g., in coordination with AMF 907, UDM 913, and/or PCF 911) may receive one or more of UE-2 905 information, USIM2 information, DualSteer device 901 information, or subscription information, along with the association information received at step 5a 929. The NF 915 (e.g., in coordination with UDM 913) may check whether the USIM2 information is associated with a DualSteer subscription and whether UE-2 905 is authorized to be associated with the DualSteer device 901. In one example, the NF 915 (e.g., in coordination with UDM 913) checks whether the DualSteer association information is consistent with what was generated at step 3a 925. In another example, the NF 915 (e.g., in coordination with UDM 913) checks whether UE-2 (e.g., and corresponding USIM2) can be associated with UE-1 903 (e.g., and corresponding USIM1). This step may check the entities (e.g., UEs) associated to UE-2 905 using the received association information (e.g., UEs associated to the specific association ID). At step 6a 931, the network ensures that the requested DualSteer/ATSSS capabilities can be used by UE-2 905 along with UE-1 903, taking into consideration subscription, policy (e.g., from PCF), and locality information. For example, the network may authorize UE-1 903 to use only switching capabilities, as UE-2 905 in this example is not physically co-located with UE-1 903. Based on determining that the authorization is successful, the NF 915 (e.g., in coordination with UDM 913) may update the subscription/association information to include details of UE-2 905.

At step 7a 933, UE-2 905 may receive a fifth message including a response to the registration, registration update, or UE association request. This response may include DualSteer/ATSSS capabilities that are authorized, and time duration corresponding to the validity of the association ID and/or the association itself. The response may also include UE association information. For example, this message may include the association ID.

At step 8a 935, UE-2 905 may update UE-1 903 on the registration status as well as any changes to association information, e.g., through the DualSteer layer and/or IMCF 660.

In the example described above (e.g., corresponding to scenario A of FIG. 9), UE-2 905 registers as a result of the registration of UE-1 903. However, in other examples, UE-2 905 uses registration procedures used by UE-1 903 to register first, which may trigger UE-1 903 to register using the procedures described to be performed by UE-2 905 above.

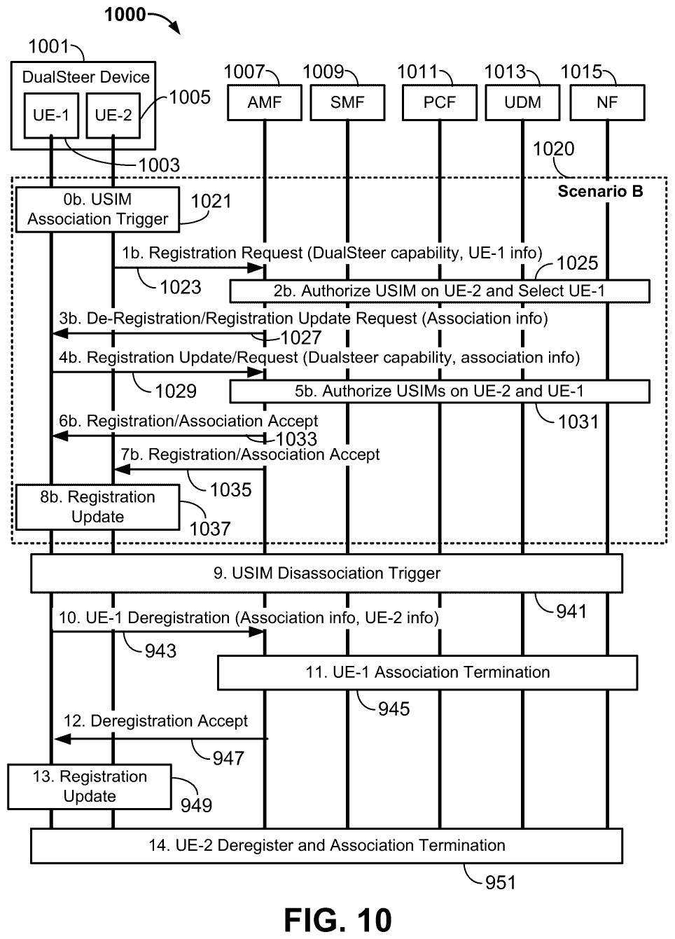

The remaining steps (i.e., steps 9-14) that are shown in FIG. 9 are described below in connection with FIG. 10, because these steps are the same for both Scenario A 920 and Scenario B 1020, as respectively annotated in FIGS. 9 and 10. Succinctly, these remaining steps conclude the registration process. After completing these steps, the DualSteer device 901 or 1001 performs DualSteer functions based on the time duration and on the authorized DualSteer capabilities.

FIG. 10 shows an illustrative flowchart of a method 1000 for executing a registration procedure for associating USIMs with the same DualSteer device. The method 1000 is performed by DualSteer device 1001 (e.g., any suitable WTRU 102), which includes UE-1 1003 and UE-2 1005, based on communications with a wireless network (e.g., including AMF 1007, SMF 1009, PCF 1011, UDM 1013, and NF 1015). As used in connection with FIG. 10, each of the DualSteer device, UE-1, UE-2, AMF, SMF, PCF, UDM, and NF may, in some embodiments, be the same as those corresponding elements of FIG. 9. For ease of comprehension, both UEs are shown registering to the same AMF. In some embodiments, UEs can register to different AMFs.

In one example, the network asks the device to determine which UEs to use for the DualSteer session. In another example, security procedures and/or policies require UE-1 1003 to re-register with information of UE-2 1005. In these examples, as shown in FIG. 10, the network may initiate a DualSteer device 1001 registration procedure (e.g., Scenario B 1020 of FIG. 10, consisting of steps 0b-8b). At step 0b 1021, the USIM association may be triggered at the DualSteer device 1001 (e.g., by one or more association triggers described above).

At step 1b, UE-2 1005 may send a first message including a registration and/or registration update request message to the network (e.g., to AMF 1007). This request may specify DualSteer capabilities to be used with UE-1 1003 and may include information of UE-1 1003 (e.g., IMEI). For example, the request may specify ATSSS capabilities that may be used (e.g., switching, steering, and/or splitting). The request may additionally specify whether the registering UE (e.g., UE-2 1005) is a primary or a secondary UE.

At step 2b 1025, a NF 1015 (e.g., in coordination with AMF 1007, UDM 1013, and/or PCF 1011) authorizes the USIM on UE-2 1005 and selects UE-1 1003 for associating with UE-2 1005. To make this authorization at step 2b 1025, the NF 1015 receives one or more of UE-2 1005 information, USIM2 information, DualSteer device 1001 information, or subscription information. The NF 1015 (e.g., in coordination with UDM 1013) may determine that UE-2 1005 can be associated to DualSteer device 1001 based on checking whether the USIM2 information is associated with a DualSteer subscription. At step 2b 1025, NF 1015 may additionally determine whether there is another UE that can be associated with UE-2 1005. For example, the NF 1015 (e.g., in coordination with UDM 1013) may check if UE-2 1005 is already associated or can be associated with another UE (e.g., UE-1 1003). The NF 1015 (e.g., in coordination with UDM 1013) may check subscription information to determine whether there are UEs that can be associated with UE-2 1005. The NF 1015 (e.g., in coordination with UDM 1013) may communicate with a database that stores information of UEs and/or USIMs to determine whether there are UEs that may be associated with UE-2 1005. The NF 1015 (e.g., in coordination with UDM 1013) may select the UEs (e.g., UE-1 1003) for associating with UE-2 1005, e.g., based on information gathered within the network and/or information of UE-1 1003 received at step 1b 1023. In another example, the NF 1015 (e.g., in coordination with UDM 1013) provides a list of UEs (e.g., including UE-1 1003) to another function connected to NF 1015 (e.g., SMF 1009, AMF 1007, and/or any suitable NEF) that may be associated with UE-2 1005. The NF 1015 (e.g., in coordination with UDM 1013) may select one or more UEs and send information corresponding to the selected UEs to the AMF 1007. The UDM 1013 may communicate with PCF 1011 to check if the current policy allows UE-2 1005 to be associated with the chosen UE-1 1003.

Step 2b 1025 ensures that the requested DualSteer/ATSSS capabilities can be used by the UE-2 1005 and UE-1 1003. At step 2b, the NF 1025 (e.g., in coordination with UDM 1013) may generate association information to be used for associating (e.g., only) UE-2 1005 with UE-1 1003 in the future. This association information may include an association ID and may be provided to the corresponding AMF 1007 along with subscription data. The association information (e.g., association ID) may be used to derive or map, information of associated UE-1 1003 (e.g., and corresponding USIM1) and UE-2 1005 (e.g., and corresponding USIM2).

At step 3b 1027, UE-1 1003 may receive a second message including a registration update/de-registration request from the network (e.g., from AMF 1007). The request may specify that UE-2 1005 is attempting to register with the network to be a part of the DualSteer device 1001 and may additionally include UE/USIM information corresponding to UE-2 1005. In one example, the request includes association information generated in step 2b 1025. For example, at step 3b 1027, the UE-1 1003 may receive a registration update request including a message corresponding to a new message type. In another example, the included message is a UE configuration update message. In another example, UE-1 1003 is a primary UE and is not yet registered. At step 2b 1025, the unregistered UE-1 1003 may receive a new network-triggered registration request. This request may be sent as a broadcast message including information of UE-1 1003.

In one example, UE-1 1003 is a primary UE, and the registration update/de-registration request message is a registration/configuration update request. In another example, UE-1 1003 is a secondary UE, and the registration update/de-registration request message is a de-registration request.

In one example, UE-1 1003 is associated with high priority flows and the registration update/de-registration request message is a registration/configuration update request. In another example, UE-1 1003 is determined not to be associated with low priority flows and the registration update/de-registration request message is a deregistration request, enabling UE-1 1003 to readily handle high priority flows.

At step 4b 1029, UE-1 1003 may send a third message including a registration update and/or a registration request to the network (e.g., to AMF 1007). The request may include DualSteer capability information and association information (e.g., USIM information, UE information, DualSteer device 1001 information, subscription information). In one example, based on receiving a de-registration request at step 3b 1027, UE-1 1003 terminates the existing registration, and then send a new registration request to the network (e.g., to AMF 1007). This request may specify whether the registering UE (e.g., UE-1 1003) is a primary or a secondary UE.

At step 5b 1031, NF 1015 (e.g., in coordination with AMF 1007, UDM 1013 and/or PCF 1011) authorizes USIMs on UE-2 1005 and on UE-1 1003. To perform this authorization, the NF 1015 may, at step 5b 1031, receive one or more of UE-1 1003 information, USIM1, DualSteer device 1001 information, or subscription information, and the association information. The NF 1015 (e.g., in coordination with UDM 1013) may check whether the received USIM1 information is associated with UE-2 1005 and a DualSteer subscription. In one example, NF 1015 then provides the authorization information to the AMF 1007.

At step 6b 1033 and step 7b 1035, UE-1 1003 and UE-2 1005 receive fourth and fifth messages, respectively, including responses to their corresponding registration requests. At step 8b 1037, the UEs may update each other of their registration status as well any changes to association information, e.g., through the DualSteer layer and/or IMCF 660.

In the example described above (e.g., corresponding to scenario B 1020 of FIG. 10), UE-1 1003 registers as a result of the registration of UE-2 1005. However, in other examples, UE-1 1003 uses registration procedures used by UE-2 1005 to register first, which may trigger UE-2 1005 to register using the procedures described to be performed by UE-1 1003 above.

In accordance with some embodiments of this disclosure, steps 9-14 of FIGS. 9 and 10, which are implemented to disassociate associated UEs/USIMs, are described as follows.

At step 9 941, USIM disassociation may be triggered (e.g., by detection of one or more disassociation triggers described above, or based on an authorized time duration having lapsed), e.g., by the UE and/or the network. In some examples, the disassociation trigger occurs and/or is detected at UE-1 (e.g., UE-1 903 or 1003). At step 10 943, UE-1 may send a deregistration request to the network (e.g., AMF 907 or 1007). The deregistration request message may include association information (e.g., USIM information, UE information, DualSteer device 901 or 1001 information, Subscription information). The deregistration request message may additionally indicate what to do with other associated UEs. In one example, UE-1 is a primary UE, and the deregistration request indicates that other associated UEs are to be de-registered/terminated at the same time (e.g., after a timer value). In another example, the deregistration request indicates that the network may send a de-registration request to other associated UEs but wait for UEs to first accept this request.

At step 11 945, NF 915 or 1015 (e.g., in coordination with either of the AMFs, SMFs, and/or UDMs shown in FIGS. 9 and 10), may determine how to handle any existing sessions and flows of UE-1. For example, the network may determine one or more of the following: sessions and/or flows are to be transferred to an associated UE, all sessions are to be terminated, or existing traffic is handled based on policy information received from a PCF.

At step 12 947, UE-1 may receive a deregistration accept message. This message may indicate how traffic is to be handled. In one example, UE-1 is a primary UE, and a secondary UE is still registered. This message may indicate that UE-2 may now become the primary UE. Alternatively, this message may trigger UE-2 to re-register as a primary UE.

At step 13 949, UE-1 may notify UE-2 about the deregistration, e.g., via the DualSteer layer and/or IMCF 660. At step 14 951, UE-2 may deregister with the network, e.g., based on the determination made by the network in step 11 945. For example, deregistration may be network triggered. The association information may be updated with the status of UE-2.

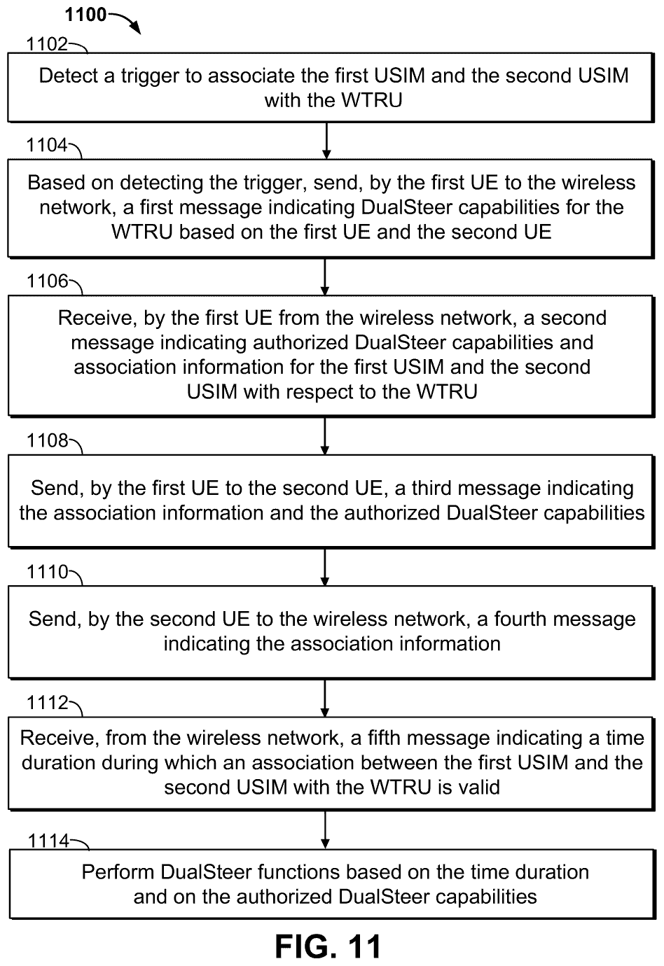

FIG. 11 shows a flowchart of an illustrative method performed by a DualSteer device (e.g., WTRU 102 of FIGS. 1A-D, or DualSteer device 901 or 1001) in connection with a wireless network (e.g., core network 106, core network 115, the wireless network described in connection with FIG. 9, or the wireless network described in connection with FIG. 10) to associate multiple USIMs.

In certain representative embodiments, a process 1100 of FIG. 11 is performed by a WTRU consisting of a first UE (e.g., UE-1 of FIGS. 9-10), a second UE (e.g., UE-2 of FIGS. 9-10), a first USIM (e.g., associated with the first UE), and a second USIM (e.g., associated with the second UE). The WTRU may be a DualSteer device that is communicatively coupled to any of the network architecture of FIGS. 2-5. The WTRU may be a DualSteer device having the components depicted in FIG. 6.

At step 1102 of process 1100, the WTRU detects a trigger to associate the first USIM and the second USIM with the WTRU. The trigger may include one or more of the association triggers describes above.

At step 1104, the WTRU, based on detecting the trigger, sends, by the first UE to the wireless network, a first message (e.g., the first message described in connection with FIG. 9) indicating DualSteer capabilities (e.g., according to any of the DualSteer architectures depicted in FIGS. 2-5) for the WTRU based on the first UE and the second UE.

At step 1106, the WTRU receives, by the first UE and from the wireless network, a second message (e.g., the second message described in connection with FIG. 9). The second message indicates the authorized DualSteer capabilities and the association information for the first USIM and the second USIM with respect to the WTRU.

At step 1108, the WTRU sends, by the first UE to send to the second UE, a third message (e.g., the third message described in connection with FIG. 9) indicating the association information and the authorized DualSteer capabilities.

At step 1110, the WTRU sends, by the second UE and to the wireless network, a fourth message (e.g., the fourth message described in connection with FIG. 9) indicating the association information.

At step 1112, the WTRU receives, from the wireless network, a fifth message (e.g., the fifth message described in connection with FIG. 9) indicating a time duration during which an association between the first USIM and the second USIM with the WTRU is valid.

At step 1114, the WTRU at step 1114 performs DualSteer functions based on the time duration and on the authorized DualSteer capabilities. For example, the DualSteer functions may include at least one of switching, steering, splitting, or duplicating communications between the WTRU and the wireless network.

In some embodiments, the process 1100 also includes, after the time duration has passed or in response to detecting a dissociation trigger, sending a sixth message to the wireless network, wherein the sixth message causes the first UE to be disassociated from the second UE with respect to the DualSteer functions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU) in communication with a wireless network, wherein the WTRU comprises:
a first user equipment (UE);
a second UE;
a first universal subscriber identity module (USIM); and
a second USIM, wherein the first UE is associated with the first USIM and the second UE is associated with the second USIM,
the method comprising:
detecting a trigger to associate the first USIM and the second USIM with the WTRU;
based on detecting the trigger, sending, by the first UE to the wireless network, a first message indicating DualSteer capabilities for the WTRU based on the first UE and on the second UE;
receiving, by the first UE from the wireless network, a second message indicating authorized DualSteer capabilities and association information for the first USIM and the second USIM with respect to the WTRU;
sending, by the first UE to the second UE, a third message indicating the association information and the authorized DualSteer capabilities;
sending, by the second UE to the wireless network, a fourth message indicating the association information;
receiving, from the wireless network, a fifth message indicating a time duration during which an association between the first USIM and the second USIM with the WTRU is valid; and
performing DualSteer functions based on the time duration and on the authorized DualSteer capabilities.

2. The method of claim 1, further comprising, after the time duration has passed or in response to detecting a dissociation trigger, sending a sixth message to the wireless network, wherein the sixth message causes the first UE to be disassociated from the second UE with respect to the DualSteer functions.

3. The method of claim 1, wherein the DualSteer functions comprise at least one of switching, steering, splitting, or duplicating communications between the WTRU and the wireless network.

4. The method of claim 1, wherein the association information comprises at least one of:
information corresponding to the first USIM, information corresponding to the second USIM, an identifier of the first UE, an identifier of the second UE, device information of the WTRU, or subscription information of the WTRU.

5. The method of claim 1, wherein:
the fifth message further comprises at least one of a location in which the association is valid or a service for which the association is valid; and
performing the DualSteer functions is further based on the location or the service.

6. The method of claim 1, wherein the WTRU is one of a logical device or a single physical device.

7. The method of claim 1, wherein:
the first message further comprises information related to the second UE; and
the association information is based on the information related to the second UE.

8. The method of claim 1, wherein the trigger comprises at least one of:
detection of the first USIM in the WTRU;
detection of the second USIM in the WTRU;
activation of an eSIM associated with at least one of the first UE or the second UE;
powering the WTRU;
powering the first UE or the second UE;
receiving a request from the wireless network;
receiving a request from at least one of the first UE or the second UE;
a user input; or a communication policy of the wireless network.

9. A wireless transmit/receive unit (WTRU) that is communicatively coupled to a wireless network, the WTRU comprising:
a first user equipment (UE);
a second UE;
a first universal subscriber identity module (USIM);
a second USIM, wherein the first UE is associated with the first USIM and the second UE is associated with the second USIM,
a processor; and
a transceiver coupled to the processor, wherein the WTRU is to:
detect a trigger to associate the first USIM and the second USIM with the WTRU;
based on detecting the trigger, send by the first UE, to the wireless network, a first message indicating DualSteer capabilities for the WTRU based on the first UE and on the second UE;
receive by the first UE, from the wireless network, a second message indicating authorized DualSteer capabilities, and association information for the first USIM and the second USIM with respect to the WTRU;
send, by the first UE to the second UE, a third message indicating the association information and the authorized DualSteer capabilities;
send, by the second UE to the wireless network, a fourth message indicating the association information;
receive, from the wireless network, a fifth message indicating a time duration during which an association between the first USIM and the second USIM with the WTRU is valid; and
perform DualSteer functions based on the time duration and on the authorized DualSteer capabilities.

10. The WTRU of claim 9, wherein the WTRU is further to, after the time duration has passed or in response to detecting a dissociation trigger, send a sixth message to the wireless network, wherein the sixth message causes the first UE to be disassociated from the second UE with respect to the DualSteer functions.

11. The WTRU of claim 9, wherein the DualSteer functions comprise at least one of switching, steering, splitting, or duplicating communications between the WTRU and the wireless network.

12. The WTRU of claim 9, wherein the association information comprises at least one of: information corresponding to the first USIM, information corresponding to the second USIM, an identifier of the first UE, an identifier of the second UE, device information of the WTRU, or subscription information of the WTRU.

13. The WTRU of claim 9, wherein:
the fifth message further comprises at least one of a location in which the association is valid or a service for which the association is valid; and
performing the DualSteer functions is further based on the location or the service.

14. The WTRU of claim 9, wherein the WTRU is one of a logical device or a single physical device.

15. The WTRU of claim 9, wherein:
the first message further comprises information related to the second UE; and
the association information is based on the information related to the second UE.

16. The WTRU of claim 9, wherein the trigger comprises at least one of:
detection of the first USIM in the WTRU;
detection of the second USIM in the WTRU;
activation of an eSIM associated with at least one of the first UE or the second UE;
powering the WTRU;
powering the first UE or the second UE;
receiving a request from the wireless network;
receiving a request from at least one of the first UE or the second UE;
a user input; or
a communication policy of the wireless network.

17. A network that is communicatively coupled to a wireless transmit/receive unit (WTRU), the network comprising:
a processor; and
a transceiver coupled to the processor, wherein the network is to:
receive, from a first user equipment (UE) of the WTRU, a first message indicating DualSteer capabilities for the WTRU based on the first UE and on a second UE of the WTRU;
send, to the first UE, a second message indicating authorized DualSteer capabilities, and association information, with respect to the WTRU, for a first universal subscriber identity module (USIM) of the first UE and a second USIM of the second UE;
receive, from the second UE, a fourth message indicating the association information;
authorize a time duration during which an association between the first USIM and the second USIM with the WTRU is valid; and
send a fifth message indicating the authorized time duration, wherein the WTRU is to perform DualSteer functions based on the time duration and on the authorized DualSteer capabilities.

18. The network of claim 17, wherein the network is further to, after the time duration has passed or in response to detecting a dissociation trigger, disassociate the first UE from the second UE with respect to the DualSteer functions.

19. The network of claim 17, wherein the DualSteer functions comprise at least one of switching, steering, splitting, or duplicating communications between the WTRU and the network.

20. The network of claim 17, wherein the association information comprises at least one of: information corresponding to the first USIM, information corresponding to the second USIM, an identifier of the first UE, an identifier of the second UE, device information of the WTRU, or subscription information of the WTRU.
